(19) United States
(12) Patent Application Publication
(10) Pub. No.: US 2008/0044671 A1
(43) Pub. Date: Feb. 21, 2008

(54) Transfer film having organic polymer film and method of forming thin metal layer using the transfer film

(76) Inventors: Jeong-Hee Lee, Yongin-si (KR); Tae-Won Jeong, Yongin-si (KR); Jeong-Na Heo, Yongin-si (KR); Yong-Wan Jin, Yongin-si (KR); Shang-Hyeun Park, Yongin-si (KR)

Correspondence Address: Robert E. Bushnell, Suite 300, 1522 K Street, N.W., Washington, DC, 20005, US

(21) Appl. No.: 11/785,587

(22) Filed: Apr. 18, 2007

(30) Foreign Application Priority Data
Jun. 28, 2006 (KR) 10-2006-0058894

(51) Int. Cl. B41M 3/12; B32B 15/04

(52) U.S. Cl. 428/457; 427/146

(57) ABSTRACT

A transfer film includes an organic film that can be removed using a solvent and a metal film formed on the organic film. The metal film is formed by: preparing a first substrate; forming a transfer film by stacking an organic film and a metal film on the first substrate; separating the transfer film from the first substrate; bonding the transfer film separated from the first substrate to a second substrate by arranging the metal film to face the second substrate; and removing the organic film from the metal film using a solvent.

### CLAIM OF PRIORITY

This application makes reference to, incorporates the same herein, and claims all benefits accruing under 35 U.S.C. §119 from an application for TRANSFER FILM HAVING ORGANIC POLYMER FILM AND METHOD OF FORMING METAL THIN LAYER USING THE TRANSFER FILM earlier filed in the Korean Intellectual Property Office on 28 Jun. 2006 and there duly assigned Serial No. 10-2006-0058894.

### BACKGROUND OF THE INVENTION

1. Field of the Invention

The present invention relates to a transfer film and a method of forming a metal film using the transfer film, and more particularly, the present invention relates to a transfer film having an organic polymer film and a method of forming a metal film having a smooth surface using a transferring method in which the transfer film is used.

2. Description of the Related Art

Metal films are formed in various fields and applied in image displaying apparatus, such as Cathode Ray Tubes (CRTs) or Field Emission Devices (FEDs). As such, a metal back film in which an Al metal film is formed on a surface of a phosphor layer is widely used. In this case, the formation of a high quality metal film is important. The purpose of the metal back film is to effectively emit light energy to a front face of a screen by reflecting light emitted towards the metal film from a phosphor layer being excited by electrons emitted from an electron source and to make the phosphor layer serve as an electrode by providing conductivity to the phosphor layer. Accordingly, the formation of a metal film that is very thin and has a smooth surface in order to increase reflection is necessary.

To manufacture such a metal film, the following method is used. That is, an organic polymer layer is coated on a phosphor layer in order to place a flat metal film on the phosphor layer. After the organic polymer layer dries, a metal film is placed on the organic polymer layer. The organic polymer layer is removed by a firing process. However, in this method, the metal film is damaged due to a lot of organic materials generated during the firing process. Accordingly, a non-uniform metal film is formed. In particular, when the metal film constitutes a metal back that is non-uniform, an arc discharge can occur during a high voltage operation, thereby degrading the phosphor layer. Another method of forming a metal film is transferring a film. However, also in this method, a firing process is used to remove the polymer layer, and accordingly, this method has the same problem as the method described above.

### SUMMARY OF THE INVENTION

The present invention provides a transfer film including an organic film and a metal film, in which the organic film can be removed without damaging the metal film.

The present invention also provides a method of forming a metal film having a smooth surface by removing an organic film after a transfer film including an organic film and the metal film is transferred to a desired position on a substrate.

According to an aspect of the present invention, a transfer film is provided including: an organic film, the organic film being removable with a solvent; and a metal film arranged on the organic film.

According to an aspect of the present invention, a method of forming a metal film is provided, the method including: preparing a first substrate; stacking an organic film and a metal film on the first substrate to form a transfer film; separating the transfer film from the first substrate; bonding the transfer film separated from the first substrate to a second substrate by arranging the metal film of the transfer film to face the second substrate; and removing the organic film from the metal film with a solvent.

According to another aspect of the present invention, a method of forming a metal film is provided, the method including: preparing a first substrate; stacking an organic film and a metal film on the first substrate to form a transfer film; separating the transfer film from the first substrate; forming a phosphor layer on a second substrate; bonding the transfer film separated from the first substrate to the second substrate by arranging the metal film of the transfer film to face the phosphor layer; and removing the organic film from the metal film with a solvent.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a cross-sectional view of a transfer film according to an embodiment of the present invention;

FIG. 2 is a cross-sectional view of a transfer film according to another embodiment of the present invention;

FIGS. 3A through 3D are cross-sectional views of a method of forming a metal film according to an embodiment of the present invention;

FIGS. 4A through 4D are cross-sectional views of a method of forming a metal film according to another embodiment of the present invention;

FIGS. 5A through 5G are cross-sectional views of a method of forming a metal film according to still another embodiment of the present invention;

FIGS. 6A through 6E are cross-sectional views of a method of forming a metal film according to yet another embodiment of the present invention; and

FIGS. 7A through 7E are cross-sectional views of a method of forming a metal film according to another further embodiment of the present invention.

### DETAILED DESCRIPTION OF THE INVENTION

A transfer film according to the present invention and a method of forming a metal film using the transfer film are described below with reference to the accompanying drawings, in which exemplary embodiments of the present invention are shown. The invention may, however, be embodied in many different forms and should not be construed as being limited to the embodiments set forth herein; rather, these embodiments are provided so that this disclosure will be thorough and complete, and will fully convey the concept of the present invention to those skilled in the art. In the drawings, like reference numerals refer to like elements throughout the drawings, and the thicknesses of layers and regions have been exaggerated for clarity.

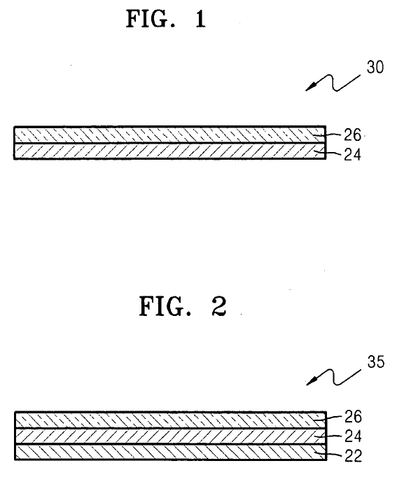

FIG. 1 is a cross-sectional view of a transfer film 30 according to an embodiment of the present invention.

The transfer film 30 includes a hydrophobic polymer layer 24 and a metal film 26 formed on the hydrophobic polymer layer 24. The hydrophobic polymer layer 24 can be formed of one selected from of hydrophobic polymer family, for example, poly alkyl acrylate, polydiene, polyolefin, poly acetone lactide, polysiloxane, polyoxirane, polystyrene, polypyridine, etc. The hydrophobic polymer layer 24 of the transfer film 30 is removed using an organic solvent after the transfer film 30 is transferred on a position where the metal film 26 will be placed. Accordingly, the metal film 26 having a smooth surface is not damaged, and can be placed where the metal film 26 is required to be placed.

FIG. 2 is a cross-sectional view of a transfer film 35 according to another embodiment of the present invention. The transfer film 35 includes a hydrophilic polymer layer 22, a hydrophobic polymer layer 24 formed on the hydrophilic polymer layer 22, and a metal film 26 formed on the hydrophobic polymer layer 24. The hydrophilic polymer layer 22 can be formed of one selected from the hydrophilic polymer family, for example, poly alkyl(acrylic) acid, poly acrylamide, poly ethylene glycol, poly ethylene oxide, poly methyl vinyl ether, poly styrensulfonic acid, poly ethylene imine, etc., and the hydrophobic polymer layer 24 can be formed of one selected from the hydrophobic polymer family, for example, poly alkyl acrylate, polydiene, polyolefin, poly acetone lactide, polysiloxane, polyoxirane, polystyrene, polypyridine, etc.

The hydrophilic polymer layer 22 and the hydrophobic polymer layer 24 of the transfer film 35 respectively can be removed using water or and an organic solvent after the transfer film 35 is transferred on a position where the metal film 26 will be placed. Accordingly, the metal film 26 is not damaged, and can be placed where the metal film 26 is required to be placed.

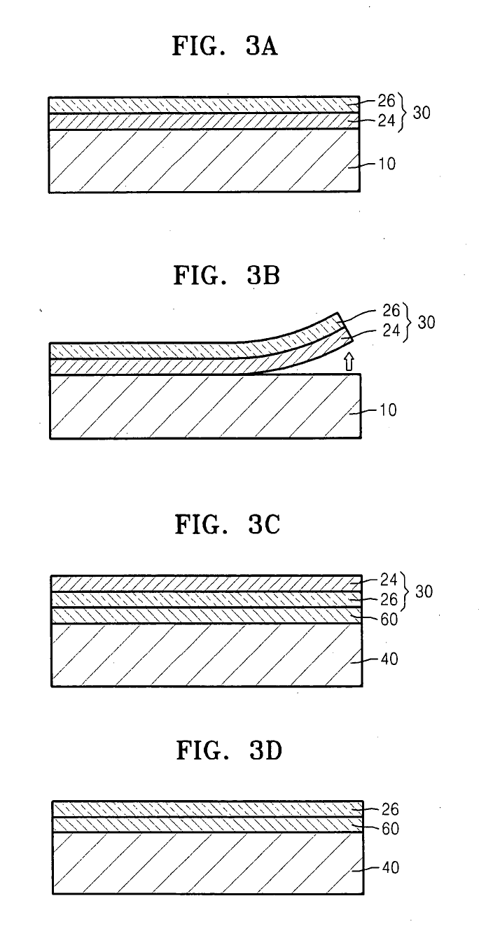

FIGS. 3A through 3D are cross-sectional views illustrating a method of forming a metal film according to an embodiment of the present invention.

Referring to FIG. 3A, a transfer film 30 is transferred on a first substrate 10. The transfer film 30 includes a hydrophobic polymer layer 24 and a metal film 26. The hydrophobic polymer layer 24 can be formed of one selected from the hydrophobic polymer family, for example, poly alkyl acrylate, polydiene, polyolefin, poly acetone lactide, polysiloxane, polyoxirane, polystyrene, polypyridine, etc.

A method of forming the transfer film 30 will now be described. First, the hydrophobic polymer layer 24 is formed on the first substrate 10. The hydrophobic polymer layer 24 can be formed by spin coating a solution with a polyisobutylmetaacrylate (PIBMA) concentration of 3 to 5% in a terpineol solvent. Afterwards, the metal film 26 is formed on the hydrophobic polymer layer 24 by depositing a metal such as Al using a sputter or an electron beam apparatus. In the present embodiment, the first substrate 10 may be hydrophilic and flexible so that the transfer film 30 formed on the first substrate 10 can be easily separated from the first substrate 10.

Referring to FIG.3B, the transfer film 30 comprised of the hydrophobic polymer layer 24 and the metal film 26 is separated from the first substrate 10 in a direction indicated by the arrow.

Referring to FIG.3C, the transfer film 30, which was separated from the first substrate 10, is bonded to a second substrate 40 by allowing the metal film 26 of the transfer film 30 to face the second substrate 40. The second substrate 40 is the final place where the metal film 26 is formed. The metal film 26 of the transfer film 30 cannot be directly formed on the second substrate 40 using a sputter or an electron beam apparatus since the second substrate 40 is not heat resistant. A process of forming an adhesive layer 60 on the second substrate 40 can further be included prior to bonding the transfer film 30 on the second substrate 40 so that the metal film 26 can firmly contact the second substrate 40.

Next, the hydrophobic polymer layer 24 is removed using a solvent. The solvent can be an organic solvent, for example, acetone. Removing the hydrophobic polymer layer 24 as depicted in FIG. 3D completes the formation of the metal film 26.

The metal film 26 formed according to the present embodiment on the second substrate 40 can maintain a surface as smooth as the surface formed on the first substrate 10 since a firing process that forms the non-uniform surface of the metal film 26 is not performed.

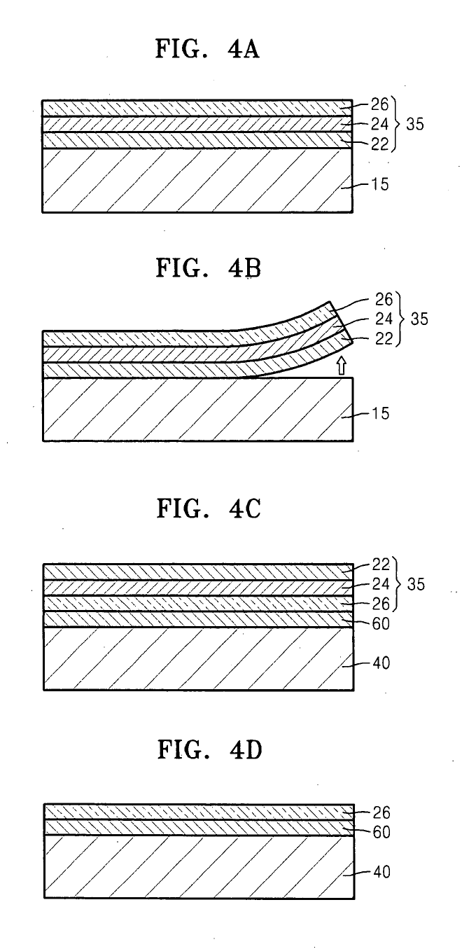

FIGS. 4A through 4D are cross-sectional views illustrating a method of forming a metal film according to another embodiment of the present invention.

Referring to FIG. 4A, a transfer film 35 is formed on a first substrate 15. The transfer film 35 includes a hydrophilic polymer layer 22, a hydrophobic polymer layer 24 formed on the hydrophilic polymer layer 22, and a metal film 26 formed on the hydrophobic polymer layer 24. The hydrophilic polymer layer 22 can be formed of one selected from the hydrophilic polymer family, for example, poly alkyl (acrylic) acid, poly acrylamide, poly ethylene glycol, poly ethylene oxide, poly methyl vinyl ether, poly styrensulfonic acid, poly ethylene imine, etc., and the hydrophobic polymer layer 24 can be formed of one selected from the hydrophobic polymer family, for example, poly alkyl acrylate, polydiene, polyolefin, poly acetone lactide, polysiloxane, polyoxirane, polystyrene, polypyridine, etc.

A method of forming the transfer film 35 will now be described. First, the hydrophilic polymer layer 22 is formed on the first substrate 15. The hydrophilic polymer layer 22 is formed by coating an aqueous solution with a polyvinylalchol concentration of 5 to 10% on the first substrate 15. Next, the hydrophobic polymer layer 24 is formed on the hydrophilic polymer layer 22. The hydrophobic polymer layer 24 can be formed by spin coating a solution with a polyisobutylmetaacrylate (PIBMA) concentration of 3 to 5% in a terpineol solvent and drying the solution. Afterwards, the metal film 26 is formed on the hydrophobic polymer layer 24 by depositing a metal such as Al using a sputter or an electron beam apparatus. In the present embodiment, the first substrate 15 may be hydrophobic and flexible so that the transfer film 35 formed on the first substrate 15 can be easily separated from the first substrate 15.

Referring to FIG. 4B, the transfer film 35 is separated from the first substrate 15 in a direction indicated by the arrow.

Referring to FIG. 4C, the transfer film 35, which was separated from the first substrate 15, is bonded to a second substrate 40 by allowing the metal film 26 of the transfer film 35 to face the second substrate 40. The second substrate 40 is the final place where the metal film 26 is formed. The metal film 26 cannot be directly formed on the second substrate 40 using a sputter or an electron beam apparatus since the second substrate 40 is not heat resistant. A process of forming an adhesive layer 60 on the second substrate 40 can further be included prior to bonding the transfer film 35 on the second substrate 40 so that the metal film 26 can firmly contact the second substrate 40.

Next, the hydrophobic polymer layer 24 is removed using a solvent, and the hydrophilic polymer layer 22 is removed using water. The solvent can be an organic solvent, for example, acetone. The removal of the hydrophilic polymer layer 22 and the hydrophobic polymer layer 24 as depicted in FIG. 4D completes the formation of the metal film 26.

The metal film 26 formed according to the present embodiment on the second substrate 40 can maintain a surface as smooth as the surface formed on the first substrate 15 since a firing process that forms the non-uniform surface of the metal film 26 is not performed.

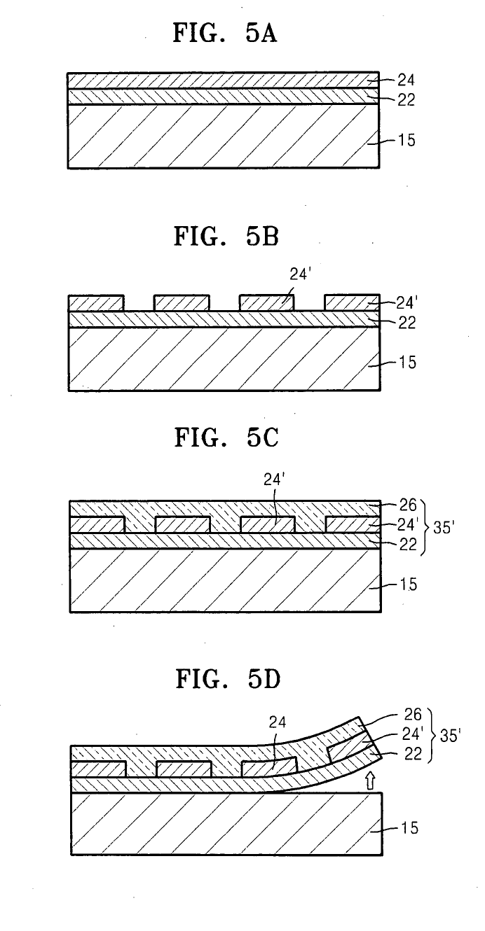

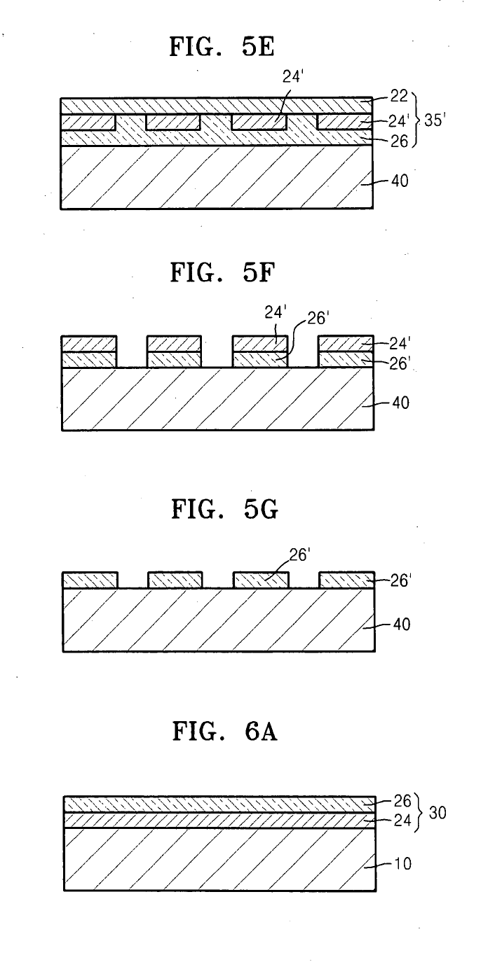

FIGS. 5A through 5G are cross-sectional views illustrating a method of forming a metal film according to another embodiment of the present invention. A method of forming a metal film having a predetermined shape will now be described with reference to FIGS. 5A through 5G.

Referring to FIG. 5A, a hydrophilic polymer layer 22 is formed on a first substrate 15, and a hydrophobic polymer layer 24 is formed on the hydrophilic polymer layer 22.

Next, as depicted in FIG. 5B, a patterned hydrophobic polymer layer 24′ having a predetermined shape is formed by patterning the hydrophobic polymer layer 24. The shape of the hydrophobic polymer layer 24′ is determined according to the shape of the metal film 26 to be formed. That is, the shape of the hydrophobic polymer layer 24′ in FIG. 5B is an example, and can be modified to other forms.

Referring to FIG. 5C, the manufacture of a transfer film 35′, which is to be separated from the first substrate 15, is completed by forming the metal film 26 on the hydrophilic polymer layer 22 and the patterned hydrophobic polymer layer 24′.

Next, referring to FIG. 5D, the transfer film 35′ is separated from the first substrate 15 in a direction indicated by the arrow.

Next, referring to FIG. 5E, the transfer film 35′, which was separated from the first substrate 15, is bonded to a second substrate 40 by allowing the metal film 26 of the transfer film 35′ to face the second substrate 40. A process of forming an adhesive layer 60 on the second substrate 40 can further be included prior to bonding the transfer film 35 on the second substrate 40 so that the metal film 26 can firmly contact the second substrate 40.

Next, the hydrophilic polymer layer 22 and the patterned hydrophobic polymer layer 24′ are removed using solvents. First, the hydrophilic polymer layer 22 is removed using water. At this time, the portions of the metal film 26 where the patterned hydrophobic polymer layer 24′ is not formed are removed together with the hydrophilic polymer layer 22. Referring to FIG. 5F, the portions of the hydrophilic polymer layer 22 and the metal film 26 are removed, and a patterned metal film 26′, which is patterned to a predetermined shape, and the patterned hydrophobic polymer layer 24′ remain. Next, when the patterned hydrophobic polymer layer 24′ is removed using an organic solvent, as depicted in FIG. 5G, the patterned metal film 26′ is formed on the second substrate 40.

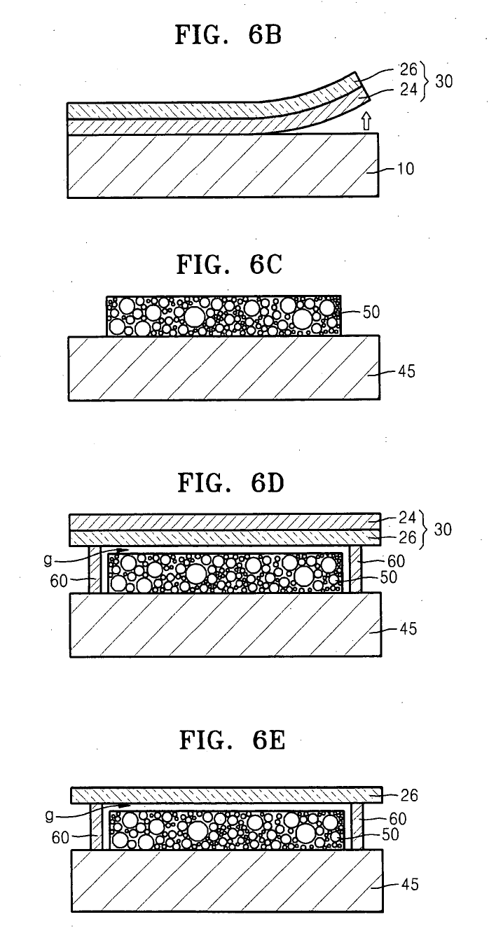

FIGS. 6A through 6E are cross-sectional views illustrating a method of forming a metal film according to an embodiment of the present invention. The present embodiment is the case when the metal film 26 illustrated in FIGS. 3A through 3D is applied to form a metal back employed in a front panel of an image displaying device. Thus, the main difference between the metal film 26 illustrated in FIGS. 3A through 3D and the metal film illustrated in FIGS. 6A through 6E will be described.

The operations illustrated in FIGS. 6A and 6B are the same as the operations illustrated in FIGS. 3A and 3B. That is, after a transfer film 30 comprising a hydrophobic polymer layer 24 and a metal film 26 is formed on a first substrate 10, the transfer film 30 is separated from the first substrate 10.

Referring to FIG. 6C, a phosphor layer 50 is formed on a second substrate 45. The second substrate 45 is used as a front panel of an image display device such as a field emission device (FED), and can be a glass substrate. An area on which the phosphor layer 50 will be formed is appropriately determined in consideration of an active region of the front panel of an image display device.

Referring to FIG. 6D, the transfer film 30, which was separated from the first substrate 10, is bonded on the second substrate 45 by allowing the metal film 26 to face the phosphor layer 50. Prior to bonding the transfer film 30 on the second substrate 45, a process of forming an adhesive layer 60 around the phosphor layer 50 can further be included. In this case, the height of the adhesive layer 60 is formed higher than the height of the phosphor layer 50 in order to form a predetermined gap g between the phosphor layer 50 and the metal film 26. Also, the gap g can be closed by appropriately controlling the adhesive force. In this way, the damage to the phosphor layer 50 that can be caused in a process of bonding the metal film 26 on the phosphor layer 50 can be reduced.

Next, when the hydrophobic polymer layer 24 is removed using an organic solvent, as depicted in FIG. 6E, the formation of the metal film 26 on the phosphor layer 50 is complete.

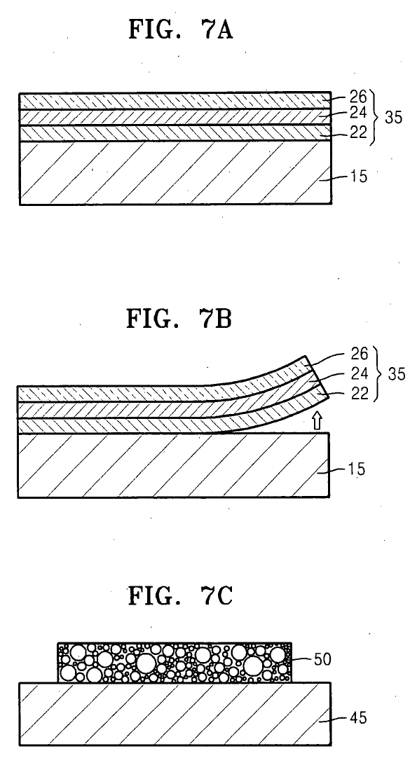

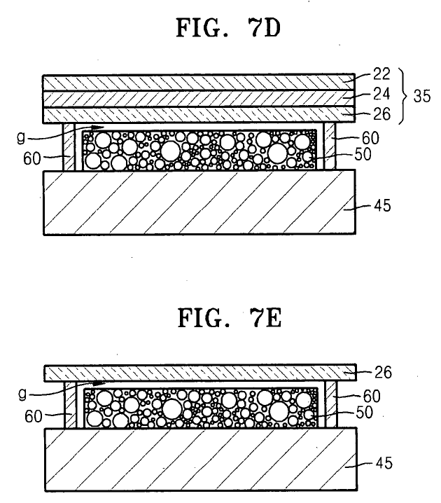

FIGS. 7A through 7E are cross-sectional views illustrating a method of forming a metal film according to another embodiment of the present invention. The present embodiment is the case when the metal film 26 in FIGS. 4A through 4D is applied to form a metal back employed in a front panel of an image displaying device. Thus, the main difference between the metal film 26 in FIGS. 4A through 4D and the metal film illustrated in FIGS. 7A through 7E will be described.

The operations illustrated in FIGS. 7A and 7B are the same as the operations illustrated in FIGS. 4A and 4B. That is, after a transfer film 35 comprising of a hydrophilic polymer layer 22, a hydrophobic polymer layer 24, and a metal film 26 is formed on a first substrate 15, the transfer film 35 is separated from the first substrate 15.

Referring to FIG. 7C, a phosphor layer 50 is formed on a second substrate 45.

Referring to FIG. 7D, the transfer film 35,which was separated from the first substrate 15, is bonded on the second substrate 45 by allowing the metal film 26 of the transfer film 35 to face the phosphor layer 50. Prior to bonding the transfer film 35 on the second substrate 45, a process of forming an adhesive layer 60 higher than the height of the phosphor layer 50 around the phosphor layer 50 can further be included. In the present embodiment, a predetermined gap g between the phosphor layer 50 and the metal film 26 can be formed or closed by appropriately controlling the adhesive force.

Next, when the hydrophilic polymer layer 22 and the hydrophobic polymer layer 24 are sequentially removed using water and an organic solvent, as depicted in FIG. 7E, the manufacture of the metal film 26 on the phosphor layer 50 is complete.

As described above, in the embodiments of the present invention, a transfer film that includes an organic film and a metal film is used. Therefore, a high quality metal film can be formed since the organic film can be removed without damaging the metal film.

The method of forming a metal film according to the present invention uses a transfer film and has the following advantages.

First, a hydrophilic polymer layer or a hydrophobic polymer layer formed on a metal film can be removed respectively using water or an organic solvent, that is, a firing process is not required. Therefore, a possibility of damaging the metal film is removed.

Second, the method of forming a metal film is useful in the case when the metal film must be formed on a substrate on which the metal film cannot be directly formed.

When the metal film is used for forming a metal back of a phosphor layer of an image display apparatus, a high quality image display apparatus can be realized since a metal film having a high reflection and a high withstanding voltage due to a smooth surface is provided.

While the present invention has been particularly shown and described with reference to exemplary embodiments thereof, it will be understood by those of ordinary skill in the art that various changes in form and details maybe made therein without departing from the spirit and scope of the present invention as defined by the following claims.

What is claimed is:

1. A transfer film comprising:
an organic film, the organic film being removable with a solvent; and
a metal film arranged on the organic film.

2. The transfer film of claim 1, wherein the organic film comprises a hydrophobic polymer layer.

3. The transfer film of claim 2, wherein the hydrophobic polymer layer comprises one material selected from a hydrophobic polymer family including poly alkyl acrylate, polydiene, polyolefin, poly acetone lactide, polysiloxane, polyoxirane, polystyrene, and polypyridine.

4. The transfer film of claim 1, wherein the organic film comprises a hydrophilic polymer layer and a hydrophobic polymer layer arranged on the hydrophilic polymer layer.

5. The transfer film of claim 4, wherein the hydrophobic polymer layer is patterned in a predetermined shape.

6. The transfer film of claim 4, wherein the hydrophilic polymer layer comprises one material selected from a hydrophilic polymer family including poly alkyl(acrylic) acid, poly acrylamide, polyethylene glycol, polyethylene oxide, polymethyl vinyl ether, poly styrensulfonic acid, and polyethylene imine; and
wherein the hydrophobic polymer layer comprises one material selected from a hydrophobic polymer family including poly alkyl acrylate, polydiene, polyolefin, poly acetone lactide, polysiloxane, polyoxirane, polystyrene, and polypyridine.

7. A method of forming a metal film, comprising:
preparing a first substrate;
stacking an organic film and a metal film on the first substrate to form a transfer film;
separating the transfer film from the first substrate;
bonding the transfer film separated from the first substrate to a second substrate by arranging the metal film of the transfer film to face the second substrate; and
removing the organic film from the metal film with a solvent.

8. The method of claim 7, wherein bonding of the transfer film separated from the first substrate to a second substrate by arranging the metal film to face the second substrate further comprises forming an adhesive layer between the second substrate and the metal film.

9. The method of claim 7, wherein the organic film comprises a hydrophobic polymer layer.

10. The method of claim 9, wherein the hydrophobic polymer layer is formed of one material selected from a hydrophobic polymer family including poly alkyl acrylate, polydiene, polyolefin, poly acetone lactide, polysiloxane, polyoxirane, polystyrene, and polypyridine.

11. The method of claim 9, wherein a surface of the first substrate is hydrophilic.

12. The method of claim 9, wherein removing the organic film from the metal film with a solvent comprises removing the hydrophobic polymer layer with an organic solvent.

13. The method of claim 7, wherein the organic film comprises a hydrophilic polymer layer and a hydrophobic polymer layer formed on the hydrophilic polymer layer.

14. The method of claim 13, wherein the hydrophilic polymer layer is formed of one material selected from a hydrophilic polymer family including poly alkyl(acrylic) acid, poly acrylamide, polyethylene glycol, polyethylene oxide, polymethyl vinyl ether, poly styrensulfonic acid, and polyethylene imine; and
wherein the hydrophobic polymer layer is formed of one material selected from a hydrophobic polymer family including poly alkyl acrylate, polydiene, polyolefin, poly acetone lactide, polysiloxane, polyoxirane, polystyrene, and polypyridine.

15. The method of claim 13, wherein forming a transfer film by stacking an organic film and a metal film on the first substrate further comprises patterning the hydrophobic polymer layer to have a predetermined shape.

16. The method of claim 13, wherein a surface of the first substrate is hydrophobic.

17. The method of claim 13, wherein removing the organic film from the metal film with a solvent comprises removing the hydrophilic polymer layer with water and removing the hydrophobic polymer layer with an organic solvent.

18. The method of claim 15, wherein removing the organic film from the metal film with a solvent comprises removing portions of the hydrophilic polymer layer and the metal film contacting the hydrophilic polymer layer with water and removing the hydrophobic polymer layer with an organic solvent.

19. A method of forming a metal film, comprising:
preparing a first substrate;
stacking an organic film and a metal film on the first substrate to form a transfer film;
separating the transfer film from the first substrate;
forming a phosphor layer on a second substrate;
bonding the transfer film separated from the first substrate to the second substrate by arranging the metal film of the transfer film to face the phosphor layer; and
removing the organic film from the metal film with a solvent.

20. The method of claim 19, wherein the organic film is a hydrophobic polymer layer.

21. The method of claim 19, wherein the hydrophobic polymer layer is formed of one material selected from a hydrophobic polymer family including poly alkyl acrylate, polydiene, polyolefin, poly acetone lactide, polysiloxane, polyoxirane, polystyrene, and polypyridine.

22. The method of claim 20, wherein a surface of the first substrate is hydrophilic.

23. The method of claim 19, wherein removing the organic film from the metal film with a solvent comprises removing the hydrophobic polymer layer with an organic solvent.

24. The method of claim 19, wherein the organic film comprises a hydrophilic polymer layer and a hydrophobic polymer layer formed on the hydrophilic polymer layer.

25. The method of claim 24, wherein the hydrophilic polymer layer is formed of one material selected from a hydrophilic polymer family including poly alkyl(acrylic) acid, poly acrylamide, polyethylene glycol, polyethylene oxide, polymethyl vinyl ether, poly styrensulfonic acid, polyethylene imine; and
wherein the hydrophobic polymer layer is formed of one material selected from a hydrophobic polymer family including poly alkyl acrylate, polydiene, polyolefin, poly acetone lactide, polysiloxane, polyoxirane, polystyrene, and polypyridine.

26. The method of claim 24, wherein a surface of the first substrate is hydrophobic.

27. The method of claim 24, wherein the removing of the organic film from the metal film with a solvent comprises removing the hydrophilic polymer layer with water and removing the hydrophobic polymer layer with an organic solvent.

28. The method of claim 19, wherein bonding the transfer film separated from the first substrate to the second substrate by arranging the metal film of the transfer film to face the phosphor layer comprises forming an adhesive layer between the second substrate and the metal film.

29. The method of claim 28, wherein bonding the transfer film separated from the first substrate to the second substrate by arranging the metal film of the transfer film to face the phosphor layer comprises bonding the transfer film to the second substrate to form a predetermined gap between the metal film and the phosphor layer by forming the adhesive layer around the phosphor layer to be higher than a height of the phosphor layer and controlling the adhesive force between the metal film and the adhesive layer.
